(19) United States
(12) Patent Application Publication
(10) Pub. No.: US 2004/0138341 A1
(43) Pub. Date: Jul. 15, 2004

(54) Process for making polyurethane elastomeric fiber

(76) Inventors: Katsuya Suzuki, Otsu (JP); Michiharu Miyauchi, Midori-ku (JP); Hiroshi Nishikawa, Otsu (JP)

Correspondence Address: Robert B Furr Jr, E I du Pont de Nemours & Company, Legal Patents, Wilmington, DE, 19898, US

(21) Appl. No.: 10/476,729

(22) PCT Filed: Jun. 4, 2002
(86) PCT No.: PCT/US02/17560

(30) Foreign Application Priority Data
Jun. 4, 2001 (JP) 168035/01

(51) Int. Cl. C08K 9/00

(52) U.S. Cl. 523/200

(57) ABSTRACT

A process for making spandex comprising the steps of: providing a polyurethane; adding to the polyurethane an inorganic pigment comprising titanium dioxide, which has been treated with at least one alkanol having at least five carbons to form a spin mixture; and spinning the mixture to form the spandex.

### BACKGROUND OF THE INVENTION

1. Field of the Invention

The present invention relates to a process for making an elastomeric polyurethane fiber, more particularly spandex containing an inorganic pigment comprising titanium dioxide which has been treated with particular class of alcohols.

2. Description of Background Art

It is known to ‘deluster’ synthetic fibers with titanium dioxide. The amount added to adjust the opacity and matte appearance of the fibers can range from about 0.3 wt % to as much as 5 wt %, based on the weight of the fiber.

Spandex containing treated zinc, aluminum, and magnesium oxides has been disclosed in International Patent Application WO00-09789 to have superior resistance to degradation by chlorine. A variety of inorganic materials has been treated with various agents and spun into spandex, as disclosed in U.S. Pat. No. US5,969,028 and European Patent Application EP0558758. Japanese Patent 40-4142 discloses titanium dioxide pigments treated with higher alcohols or alcoholic esters, for use in oily media.

The effect of inorganic additives on the manufacture of relatively low-tenacity fibers like spandex is especially marked because of the need for the just-spun, weak threadline to support itself, and an improved spinning process for making spandex is still needed.

### SUMMARY OF THE INVENTION

The present invention provides a process for making spandex comprising the steps of:

providing a polyurethane;

adding to the polyurethane an inorganic pigment comprising titanium dioxide, which has been treated with at least one alkanol having at least five and less than ten carbons to form a spin mixture; and

spinning the mixture to form the spandex.

### DETAILED DESCRIPTION OF THE INVENTION

It has now been found that, in a process for making spandex containing an inorganic pigment comprising titanium dioxide, fiber spinning continuity can be unexpectedly improved when the titanium dioxide-containing pigment is treated with at least one alcohol having at least five and less than ten carbons (‘alkanols’).

As used herein, ‘spandex’ means a manufactured fiber in which the fiber-forming substance is a long chain synthetic polymer comprised of at least 85% by weight of a segmented polyurethane.

Examples of inorganic pigments comprising titanium dioxide that can be used, after treatment, in the process of the invention include titanium dioxide, diluted titanium dioxide (composite titanium dioxide pigment), solid solution pigments comprising titanium dioxide (for example a yellow pigment like TiO₂-Sb₂O₃-NiO), mixtures thereof, and the like.

Examples of alkanols having at least five and less than ten carbons include 1,1,1-tris(hydroxymethyl)ethane, 1,2-hexanediol, 1-octanol, 1-hexanol, and 1,1-bis(hydroxymethyl)hexane. Examples of useful higher monovalent alcohols include decyl alcohol, lauryl alcohol, myristyl alcohol, cetyl alcohol, stearyl alcohol, dodecanol-2, oleyl alcohol, linolenol alcohol, etc.

Several methods can be adopted to treat the pigment comprising titanium dioxide, such as dipping the pigment in a solution of the alkanol, spraying a solution of the alkanol on the pigment, or dispersing the alkanol in a liquid in which the pigment is also mixed. It is preferred to mix the pigment and the alkanol together in water, and then separate the treated pigment from the water. In each case, the treatment step is followed by drying the treated pigment to remove the solvent and/or water.

For further improved spandex spinning continuity, it is preferred that the treated pigment comprising titanium dioxide be finely pulverized, for example by a high-velocity gas jet type crusher before being added to the polyurethane solution for spinning. In a high-velocity gas jet type crusher, air, steam or another gas at a high velocity is ejected from a nozzle to form a high-velocity jet that hits the pigment, so that pigment particles collide with each other and with the wall of the crusher and are thereby finely pulverized. In order to reduce color contamination of the pigment, it is also preferred that most of the parts of the equipment that contact the pigment have a Moh hardness of 8 or higher, for example ceramics, metal oxides, metal carbides, metal nitrides, metal borides, or metal silicides.

The polyurethane used in the process of this invention can be made from a polymeric glycol (for example a polyether glycol, a polyester glycol, or a polycarbonate glycol), a diisocyanate, and a diol chain extender or a diamine chain extender. Typically, a two-step method can be used in which the polymeric glycol can be reacted with the diisocyanate to form an isocyanate-terminated prepolymer (a ‘capped glycol’). The capped glycol can then be dissolved in a suitable solvent and reacted with a diol or a diamine to form the polyurethane or the polyurethaneurea (a sub-class of polyurethanes), respectively. A (diol chain-extended) polyurethane can also be prepared using a ‘one-shot’ method in which all of the ingredients can be reacted together substantially simultaneously. Other preparation methods can also be adopted such as, for diol-extended polyurethanes, melt-polymerization.

Examples of useful polyether glycols include poly(tetramethyleneether) glycol, poly(tetramethylenether-co-2-methyltetramethyleneether) glycol (prepared from tetrahydrofuran and 3-methyltetrahydrofuran), poly(tetramethyleneether-co-ethyleneether) glycol, and the like. Examples of useful polyester glycols include the reaction product of dihydroxy compounds such as ethylene glycol, 1,4-butanediol, 3-methyl-1,5-pentamethylene diol, poly(tetramethyleneether) glycol, 2,2-dimethyl-1,3-propanediol, and mixtures thereof with dibasic acids such as adipic acid, 1,10-decanedioic acid, 1,12-dodecanedioic acid, and mixtures thereof. Examples of useful polycarbonate glycols include poly(pentane-1,5-carbonate)diol, poly(hexane-1,6-carbonate)diol, and the like.

Examples of useful diisocyanates include 1-isocyanato-4-[(4-isocyanatophenyl)methyl]benzene (preferred), 1-isocyanato-2-[(4-isocyanatophenyl)-methyl]benzene, 1,1′-methylenebis(4-isocyanatocyclohexane), 1,3-diisocyanato-4-methylbenzene, 5-isocyanato-1-(isocyanatomethyl)-1,3,3-trimethylcyclohexane, hexamethylene diisocyanate, and mixtures thereof.

Examples of useful chain extenders for polyurethaneureas include diamines such as ethylenediamine, 1,3-cyclohexanediamine, 1,4-cyclohexanediamine, 2-methyl-1,5-diaminopentane, 1,3-diaminopentane, 1,2-diaminopropane, and mixtures thereof. Examples of useful chain extenders for polyurethanes include diols such as ethylene glycol, 1,3-propanediol, 1,4-butanediol, neopentyl glycol, 1,2-propylene glycol, 1,4-cyclohexanedimethanol, 1,4-cyclohexanediol, 1,4-bis(β-hydroxyethoxy)benzene, bis(β-hydroxyethyl)terephthalate, paraxylylenediol, and mixtures thereof. A chain terminator such as diethylamine, butylamine, cyclohexylamine, n-butanol, and the like can be added to help adjust the final molecular weight of the polyurethaneurea.

For best spandex properties, it is preferred that a polyurethaneurea be prepared in a polar aprotic solvent such as N,N-dimethylacetamide (DMAc), N,N-dimethylformamide, N-methyl pyrrolidone, or dimethyl sulfoxide, and dry-spun.

For good spinning continuity without excessive pressure drop at the spinneret, it is preferred that a solvent-containing spin mixture have a viscosity in the range of 2500-5500 Poise, as determined in general accordance with the method of ASTM D1343-69, using a Model DV-8 Falling Ball Viscometer (sold by Duratech Corp., Waynesboro, Va.), operated at 40° C.

Other additives can also be present in the spin mixture, provided they do not have a deleterious effect on the benefit of the invention. Examples include benzotriazole or other UV screeners, hindered amine light stabilizers, oxidation inhibitors such as hindered phenols, silicone oil, other pigments, hydrotalcite, barium sulfate, zinc oxide, silver compounds, mixtures of huntite and hydromagnesite, condensation polymers of p-cresol and divinyl benzene, polymers of bis(4-isocyanatocyclohexyl)methane and 3-t-butyl-3-aza-1,5-pentanediol, poly(vinylidene difluoride) and the like.

A spin finish such as silicone oil or mineral oil can be applied to the spandex during spinning, which can be carried out at a speed of at least about 450 m/min. The spandex can be wound up such that the ratio of the velocity of the godet roll to the velocity of the winder can be in the range of 1.15-1.4 for high set and low stress relaxation, or 1.36-1.65 for low set and high stress relaxation.

### EXAMPLES

### Example 1

1-Isocyanato-4-[(4-isocyanatophenyl)methyl]benzene and poly(tetramethyleneether) glycol (number-average molecular weight 1800) (1.58 to 1 molar ratio of diisocyanate to glycol) were reacted at 90° C. for about 3 hours to form a capped glycol containing 2.22 wt % (calculated) isocyanate. The capped glycol was diluted with DMAc. Then, a DMAc solution of ethylenediamine and diethylamine was added, and the mixture was blended at room temperature using a commercially available high-velocity agitator to form a DMAc solution of 35 wt % polyurethaneurea. Then, an inorganic particulate comprising titanium dioxide which had been treated with 1,1,1-tris(hydroxymethyl)ethane (Tipaque® PF-711 from Ishihara Sangyo Kaisha, Ltd.) and having a median particle size of 0.27 μm, 1.6 wt %), a polymer of bis(4-isocyanatocyclohexyl)methane and 3-t-butyl-3-aza-1,5-pentanediol (Methacrol® 2462, a registered trademark of E. I. du Pont de Nemours and Company, 2.9 wt %), a condensation polymer of p-cresol and divinyl benzene (Methacrol® 2390, a registered trademark of E. I. du Pont de Nemours and Company, 1.2 wt %), silicone oil (0.6 wt %), and an anthraquinone brightener (KP-32, Clariant Corp., 0.001 wt %) were added to the polyurethane DMAc solution to form a spin mixture for spinning spandex. All weight percent values were based on final fiber weight. Spandex (44 dtex, 4 filaments) was conventionally dry-spun at 650 m/min through spinneret capillaries having an internal diameter of 0.23 mm, coalesced, and wound up. The fiber breakage rate during spinning was only 0.01 per hour. That is, the spinnability was unexpectedly good.

### Comparison Example 1

The same polyurethanurea solution as in Example 1 was prepared. Then, an inorganic pigment comprising titanium dioxide which had not been treated with an organic compound (Ti-Pure® R-902, a registered trademark of E. I. du Pont de Nemours and Company; median particle size 0.42 μm, 1.6 wt %) and the other additives described in Example 1 were added in DMAc. The resulting spin mixture was conventionally dry-spun at 650 m/min, coalesced, and wound up as in Example 1. Spinnability was poor, since the spandex breakage rate during spinning was undesirably high at 0.3 breaks per hour.

It was unexpected that a titanium dioxide-containing pigment treated according to the invention would have a noticeable, let alone desirable, effect on spandex spinning continuity since the pigment particle size (0.25 μm) was so much smaller than the spinneret internal diameter (230 μm) and when untreated pigment of only slightly larger particle size (0.42 μm) gave much worse spinning continuity. One might speculate on several possible reasons for the observed improved spinning continuity. Perhaps the treated pigment used in the process of the invention is more compatible with polyurethane than is untreated pigment, or more readily dispersible in a polyurethane/DMAc solution, or less adherent to metal surfaces like spinneret capillaries.

What is claimed is:

1. A process for making spandex comprising the steps of:
providing a polyurethane;
adding to the polyurethane an inorganic pigment comprising titanium dioxide, which has been treated with at least one alkanol having at least five carbons to form a spin mixture; and
spinning the mixture to form the spandex.

2. The process of claim 1 wherein said alkanol has less than ten carbons.

3. The process of claim 1 wherein the polyurethane is provided in a spinning solvent, and the spinning step is a dry-spinning step.

4. The process of claim 3 wherein the chemical compound is 1,1,1-tris(hydroxymethyl)ethane.

5. The process of claim 3 wherein the polyurethane comprises the reaction product of a polyether glycol, a diisocyanate selected from the group consisting of 1-isocyanato-4-[(4-isocyanatophenyl)methyl]benzene, 1-isocyanato-2-[(4-isocyanatophenyl)-methyl]benzene, and mixtures thereof, and a chain extender selected from the group consisting of ethylene diamine, 1,2-diaminopropane, 1,3-cyclohexanediamine, 2-methyl-1,5-diaminopentane, and 1,3-diaminopentane, and mixtures thereof.

6. The process of claim 2 wherein the alkanol is selected from the group consisting of 1,2-hexanediol, 1-octanol, 1-hexanol, and 1,1-bis(hydroxymethyl)hexane.
